(19) United States
(12) Patent Application Publication
(10) Pub. No.: US 2010/0131091 A1
(43) Pub. Date: May 27, 2010

(54) A METHOD AND RELATIVE DEVICE FOR THE MANAGEMENT OF TECHNOLOGICAL RECIPE INFORMATION TO AID IN DEFINING PROCESS FLOWS, IN PARTICULAR FOR THE DEVELOPMENT AND PRODUCTION OF MICRO-AND NANOTECHNOLOGY DEVICES IN CLEANROOM LABORATORIES

(76) Inventor: Lorenza Ferrario, Povo (IT)

Correspondence Address: ABELMAN, FRAYNE & SCHWAB, 666 THIRD AVENUE, 10TH FLOOR, NEW YORK, NY, 10017, US

(21) Appl. No.: 12/452,896

(22) PCT Filed: Jul. 24, 2008
(86) PCT No.: PCT/EP2008/059710

§ 371 Date: Jan. 26, 2010

(30) Foreign Application Priority Data
Jul. 27, 2007 (IT) MI2007A001525

(51) Int. Cl. G06F 17/50

(52) U.S. Cl. 700/98; 700/104; 700/107; 700/121

(57) ABSTRACT

There is described a method for managing information to actively support the definition of new process flows, in particular in the field of micro- and nanotechnology devices typically developed in cleanroom laboratories where one or more production batches can be executed according to one reference process flow. With the use of this method it is possible to store information suited to trace the reliability and the evolution of technological recipes used into one or more production batches based on a given reference process flow. Thanks to these storing and tracing capabilities, the method addresses the selection of appropriate and reliable recipes while designing new process flows, thus favoring the definition of highly reliable new processes. The method is general and transparent with respect to different recipe types, recipe structures and technologies.

### FIELD OF THE INVENTION

The present invention relates to a method and relative device for the storage and use of technological processing information in information systems to aid in defining new process flows, in particular for the development and production of micro- and nanotechnology devices in cleanroom laboratories.

### STATE OF THE ART

The invention is applied to the context of information systems for the management of technological processes in cleanroom laboratories, with special attention for the development and production of micro- and nanotechnology devices.

In research laboratories and in cleanroom laboratories new production processes, required for large-scale industrialization of the latest technologies, are set up. The frequency of the demand for new production processes or even small variations in consolidated technologies makes it necessary to limit human error in the choice of these variations to a minimum, whether these are relative to individual steps or to sequences thereof.

In order to understand the complex nature of micro- and nanotechnologies, it is appropriate to distinguish the technological process of reference, in the following runsheet, from processes effectively performed in cleanroom laboratories by machine operators, the production batches, jobsheets in the following. Several jobsheets can be executed based on the same reference runsheet, with or without variations in single recipe parameter values. One runsheet can differ from another by the value of one or more technological parameters of an instruction. Moreover, it can be used once or several times, with the same modalities or with modifications such as those mentioned relative to the value of one or more parameters.

In the present document, jobsheet refers to the process flow effectively performed, i.e. the processing effectively carried out on a batch of substrates, which has a specific runsheet as reference.

Each macro instruction describes the processing operations to be performed on the batches of substrates to transform them into slices containing micro- and nanotechnology devices.

Each macro instruction contains technological and organizational information, and indications of any process controls to be implemented during processing of the batches.

The key element of the macro instruction is the recipe. It identifies the detailed description of the operations to be implemented in the macro instruction of reference.

FIG. 1 better explains the aforementioned terms runsheet, jobsheet and macro and their placing in the whole context.

Runsheets and jobsheets can contain from a few tens to over 300 macro instructions, requiring several months to be completed.

Failure of one of these steps can compromise the entire processing operation of a batch of substrates.

Currently, limitation of the number of errors, that is, attempts to make a new technological process stable and efficient is entrusted to the experience of highly skilled personnel relative to cleanroom laboratories, who are responsible for defining new technological processes, indicated in the present document as runsheets, intended as ordered sequences of individual but complex processing steps (indicated in the present document as macros or macro instructions).

As a result, a drawback in the current modus operandi is related to the amount of time employed to find the most reliable runsheet. Another drawback is due to the noteworthy resources employed in the training of new technicians by more expert technicians, since most of the knowledge related to past processing is lost, not appropriately stored.

A further drawback is related to the fact that the know-how acquired is lost when a skilled technician leaves the company, as normal reporting methods cannot be considered functional for others to learn from.

Therefore, this leads to problems in optimizing times and methods of implementation, i.e. due to incorrect operation of a machine, human errors, but above all to the choice of an unsuitable recipe for the processing operation.

There are different information systems offered by prior art which facilitate the management of process flows and relative production cycles. Common aims of different suites are actively supporting designers, warning about or forbidding “wrong design” and favoring the integration of information. For example, an application known with the trade name LiveDB® (PhoenixBV company), allows the operator to keep track of different versions of a runsheet, as well as to perform accurate statistical process control of processing results. Furthermore, this software offers a dynamic recipe definition, allowing to define recipe parameter values for new process flows extracting previous processing results by a script utility. A recent module of the same system allows to examine processing results of specific recipe types in order to optimize recipe parameter tuning. These last two utilities certainly allow using knowledge collected during processing wafer batches while designing new technologies, i.e., new process flows. Other applications such the prototype developed in the European project PROMENADE (now evolved in the commercial system XperiDesk, Process Relations company), offer a high level of integration compared to CAD/TCAD modules and allow automatic verification of the most elementary process rules, such as consistency of the dimensions of the various components of the device being processed with one another and in relation to available technology. The same system allows simulating new processes according to different recipe parameter values, taking these values from previous processing setups, thus linking a general process to specific, real cleanroom conditions.

Focusing on functions directly correlated to this method, FIG. 2 outlines the general structure of state of the art information systems for R&D and production in micro- and nano-technologies (it has to be said that most of the information systems offer many other functions required in production environments, like planning, scheduling and maintenance capabilities, just to mention some of them, not reported in FIG. 2).

A key feature is the integration from early prototyping (by means of simulation/TCAD tools) to SPC (statistical process control) and other information analysis based on process logs, i.e., storing of processing results information. This integration allows an automatic reuse of processing knowledge to optimize design of new technologies. E.g., measured recipe processing results, like etch or deposition rate, can feed process or device simulators in order to tune numerical models and reach even more accurate simulations. Nevertheless, available process logs analysis is highly specialized and process dependent: SPC algorithms for diffusion recipes are different from those for ion implantation, and tuning a diffusion simulation requires recipe parameters completely different with respect to those required to tune a mechanical stress model. Focusing on recipe management systems, they are highly equipment oriented, in the sense that they are designed to avoid or limit bad equipment setup, in order to avoid or limit single step processing failures. Recipe versioning systems, where available, allow recipe releases tracking and status management, e.g., what are suited to use, what are offline.

Those known systems are not particularly suitable to solve the above mentionel problems.

### SUMMARY OF THE INVENTION

The object of the present invention is to indicate a method of using technological information to aid the phase to define new process flows (here also indicated as runsheets) on the basis of information recorded during tests and production of analogous technological flows, thus improving user interfacing procedures, particularly in the field of development and production of micro- and nano-technology devices in cleanroom laboratories.

In particular, the present invention aims to define a general, recipe type independent method to manage information about recipe use. The method allows defining and processing one or more index of merit for technological recipes which can be calculated while designing new process flows in order to address the selection of most reliable recipes. The indices are automatically updated according to new wafer processing results so that they always give updated knowledge.

The method provides for the processing of information relative to technological recipes already tested in order to support identification of the most appropriate and reliable recipe for each step of a new technological process. This method favors the design of reliable new processes taking advantage of up to date processing experience and knowledge.

A first subject of the present invention is a process flow, in particular for a procedure for the production of micro- and nano-technology devices in cleanroom laboratories, comprising the following steps:
a planning step, wherein the number and type of information and at least one index of merit are defined, to build up one or more recipes to support the decision-making phase for the production process;
a storing step, following each production process, wherein said information relative to each recipe is stored in a data-base management system (DBMS);
a make-up step for obtaining a runsheet, wherein the recipes are selected by means of a “recipe reliability function”, which supplies said information relative to said recipes and said at least one index of merit, for the selection of the most reliable and appropriate recipes for the production process flow under development.

A further subject of the present invention is a method for the production management, in particular for a procedure for the production of micro- and nano-technology devices in cleanroom laboratories, using said process flow, comprising the following steps:
a process flow design step (B) : said runsheet is compiled, describing the processing required to fabricate a device as outlined in a CAD/TCAD-like level (A), said runsheet comprising an ordered sequence of technological steps, with details of said one or more recipes;
a substrate processing step (C): a set of substrates is processed according to process flow specifications comprised in a jobsheet;
a dynamic technology driven process logs step (D): a set of tracing information is recorded during the wafer processing step (C), said tracing information being used for determining said “recipe reliability function” for said recipe selection, contributing to the runsheet compilation in said process flow design step (B).

A still further subject of the present invention is a device for implementing the method.

A particular subject of the present invention is a method and device for the management of technological recipe information to aid in defining process flows, in particular for the development and production of micro- and nanotechnology devices in cleanroom laboratories, as better described in the claims, which form an integral part of the present description.

### BRIEF DESCRIPTION OF THE FIGURES

The invention will become fully clear from the following detailed description, given by way of a mere exemplifying and non limiting example, to be read with reference to the attached drawing figures, wherein:

FIG. 1 shows a macro process flow in a known architecture;

FIG. 2 shows prior art general architecture of advanced information systems for technology management in cleanroom laboratories;

FIG. 3 shows a general architecture of advanced information systems for technology management in cleanroom laboratories according to the invention;

FIG. 4 represents a block diagram of a workflow for defining a runsheet according to the invention;

FIG. 5 shows a screenshot of a web based software implementation of a function for the compilation of a new runsheet, where an implementation of the recipe reliability function is available;

FIG. 6 shows a possible design of information classes to be managed in order to design and implement the method according to the invention;

FIG. 7 shows a feedback path from wafer processing to design feeding recipe indices of merits according to the invention.

### DESCRIPTION OF A PREFERRED EMBODIMENT OF THE INVENTION

The invention will be now explained in particular with reference to the figures.

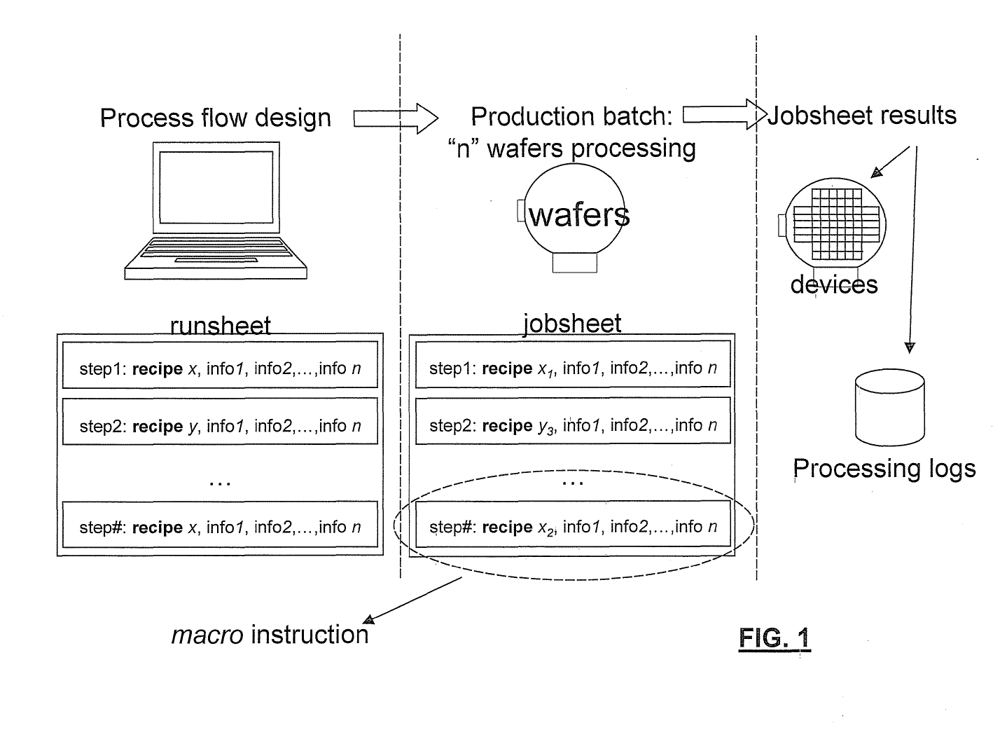

FIG. 1 explains meaning of terms runsheet, jobsheet and macro associating them to concepts more commonly known in cleanroom laboratories. Furthermore, it shows relations among the concepts.

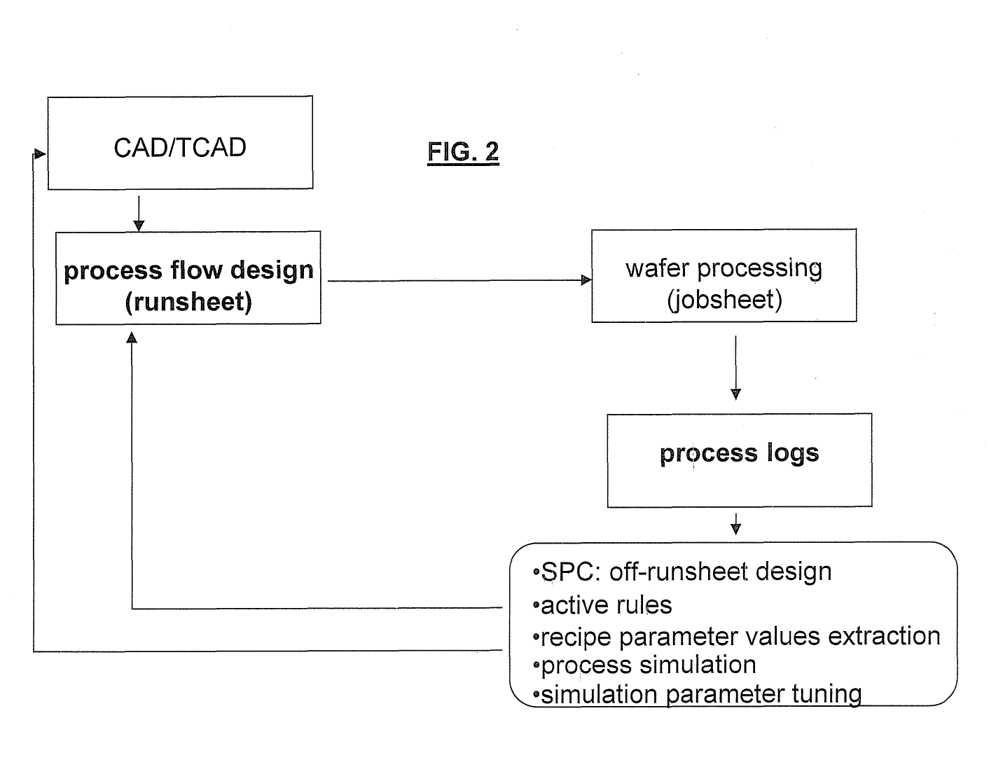

FIG. 2 outlines prior art general architecture of advanced information systems for technology management in cleanroom laboratories. It shows a processing knowledge feedback to design based on specific, technology dependent algorithms.

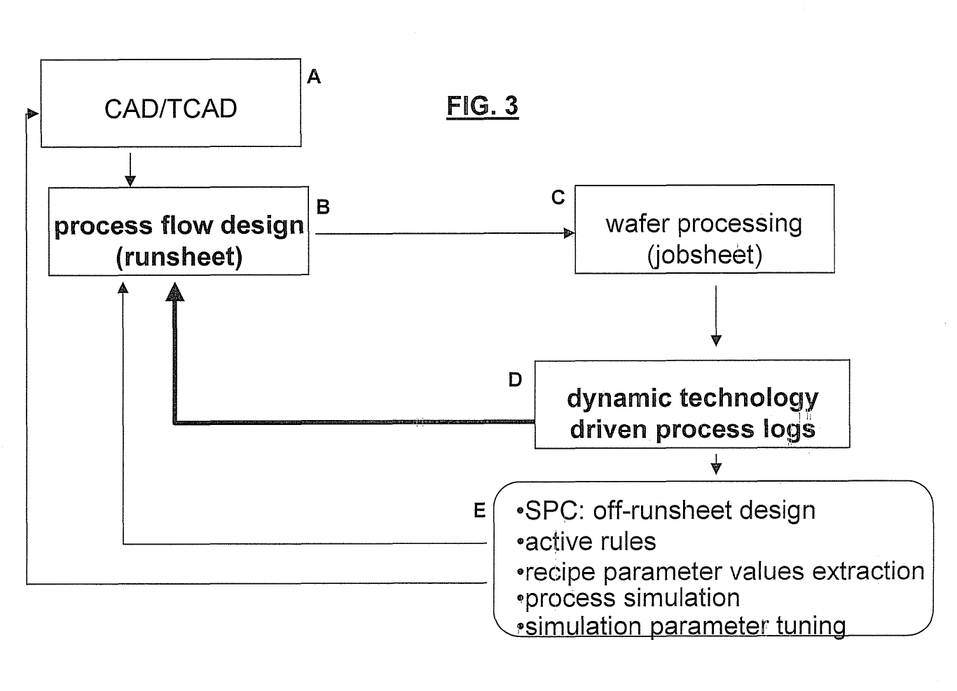

FIG. 3 shows where the invention impacts with respect to a general architecture of integrated information system for production management in cleanroom laboratories. With the definition of an appropriate structure of process logs, the method allows to directly and generally link processing results to process flow design, addressing to the choice of reliable recipes, also guaranteeing automatic update of information processed.

More in detail, blocks in FIG. 3 describe a technology development path, where:
A) CAT/TCAD step: is the simulation and design step, where numerical simulation of coupled field physics (e.g., thermo-elastic, piezoelectric), circuit simulation and layout design tools are used to outline device features. Their use is repeated once processing results and characterization data are available, after tuning of parameters. This iterative path allows tuning the software to a specific technology, for example for the production of micro- and nano-technology devices in cleanroom laboratories;
B) Process flow design step: a process flow is compiled (runsheet) describing what processing is required to fabricate a device corresponding to that outlined in the CAD/TCAD level; in this step, an ordered sequence of technological steps, with recipe details is specified;
C) Wafer processing step: a set of substrates is processed in the laboratory according to process flow specifications, implemented in a batch, or jobsheet. Cleanroom staff operates on the basis of jobsheets;
D) Dynamic technology driven process logs step: logs are all the information recorded while processing of step C), e.g., online testing, parameter values really applied, processing real times, processing results, global and step by step. They trace processing and help evaluating previous steps like simulation or process flows compilation. Logs include a set of information which can be stored, extracted and processed in the same way, independently from the technology and recipe structure; in this way the same set of indices of merit and recipe history processing is available for all recipes selected while compiling new process flows; this method allows formulating reliability evaluation of recipes independent from their nature, so giving a direct and general addressing support during the compilation of new process flows, for contributing to the runsheet definition in the process flow of step B);
E) traditional log processing step: a log processing mainly based on algorithms and methods specific for class of recipes or aims, like statistic process control (SPC) and extraction of specific recipe parameters, for contributing to the runsheet definition in the process flow of step B).

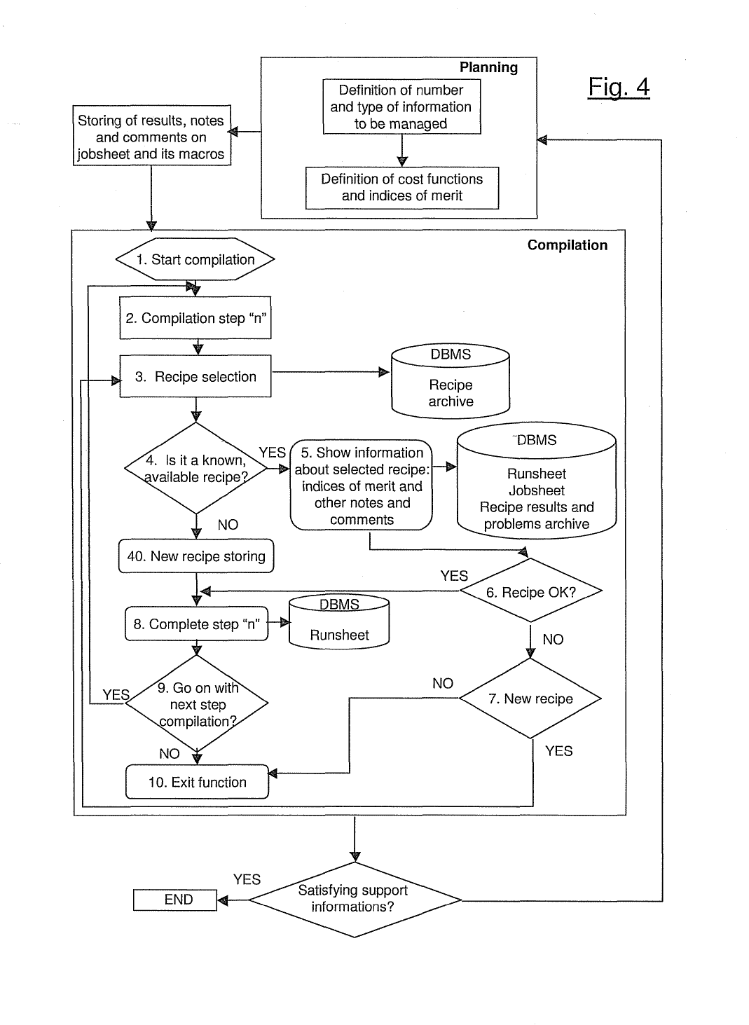

FIG. 4 represents a block diagram of a workflow for defining a runsheet. Creation of the runsheet makes use of the aid of the recipe reliability function, which offers different information to aid in making decisions, such as the history of the use of each recipe including the results and at least one index of merit calculated on the basis of said information.

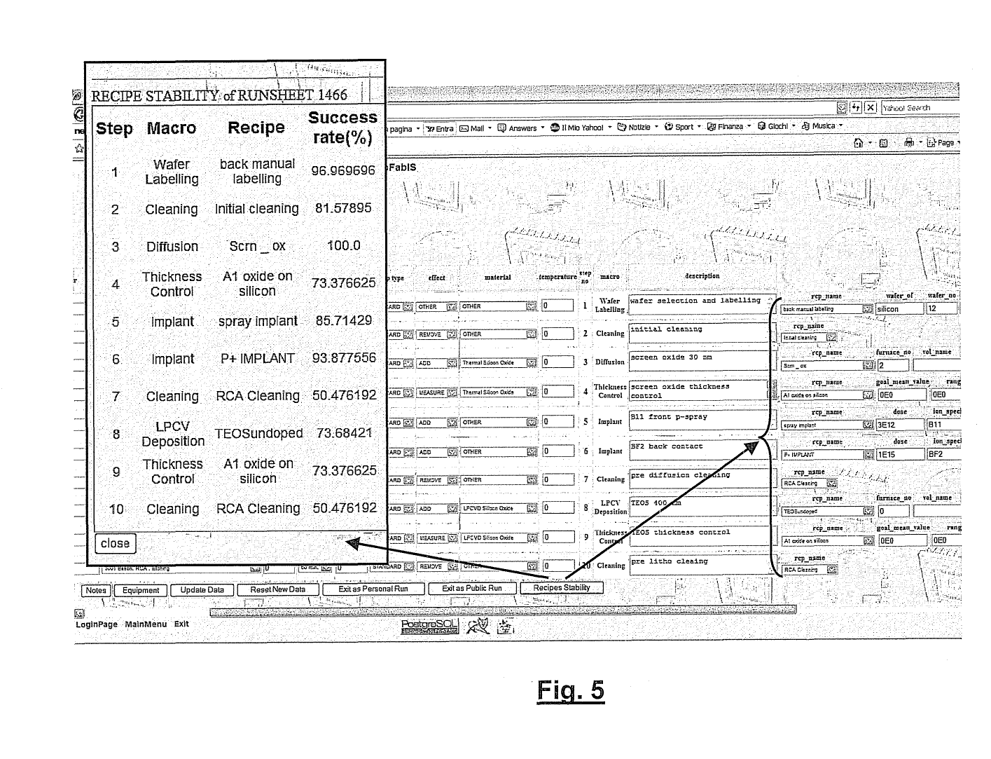

FIG. 5 shows a screenshot from a possible WEB based software implementation of a function for the compilation of a new runsheet, where an implementation of the recipe reliability function is available and produces a success rate value for each recipe used in the current version of the runsheet.

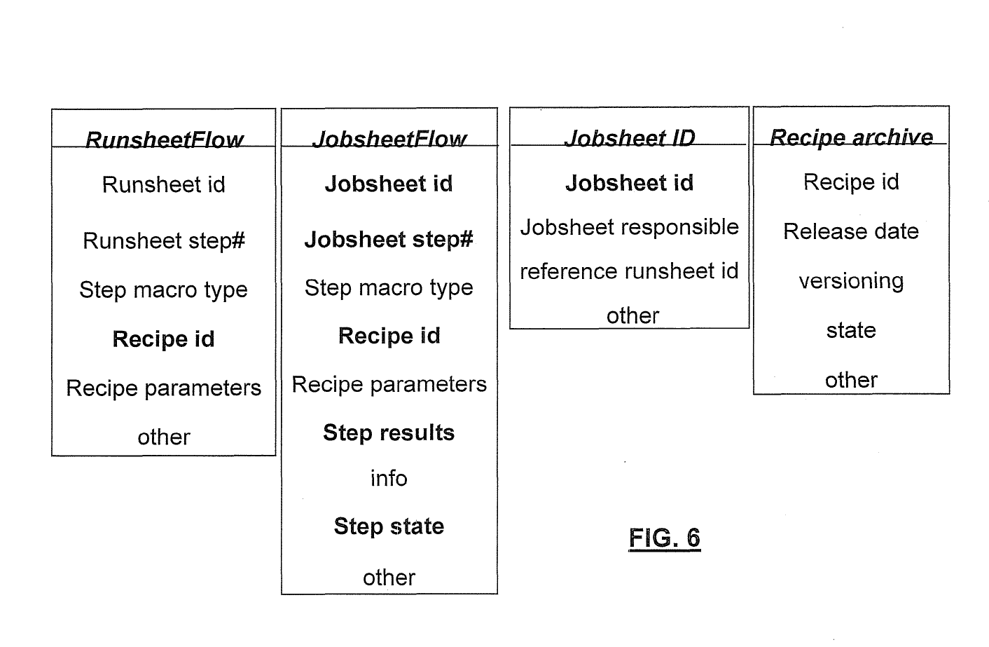

FIG. 6 shows a possible design of information classes to be managed in order to design and implement the method described. Process flow design is here represented by a RunsheetFlow structure detailing the ordered sequence of macro instructions. The JobsheetFlow structure is the information to be used by cleanroom staff to process wafers, and is updated with wafer processing results, online measurements and execution information to be used to evaluate each macro step. The JobsheetID structure is reported to show where storing “personal” information about a jobsheet, like a nickname, e reference technology, the responsible. The fourth information group is about recipes: technical and versioning information which can be retrieved by an unique id.

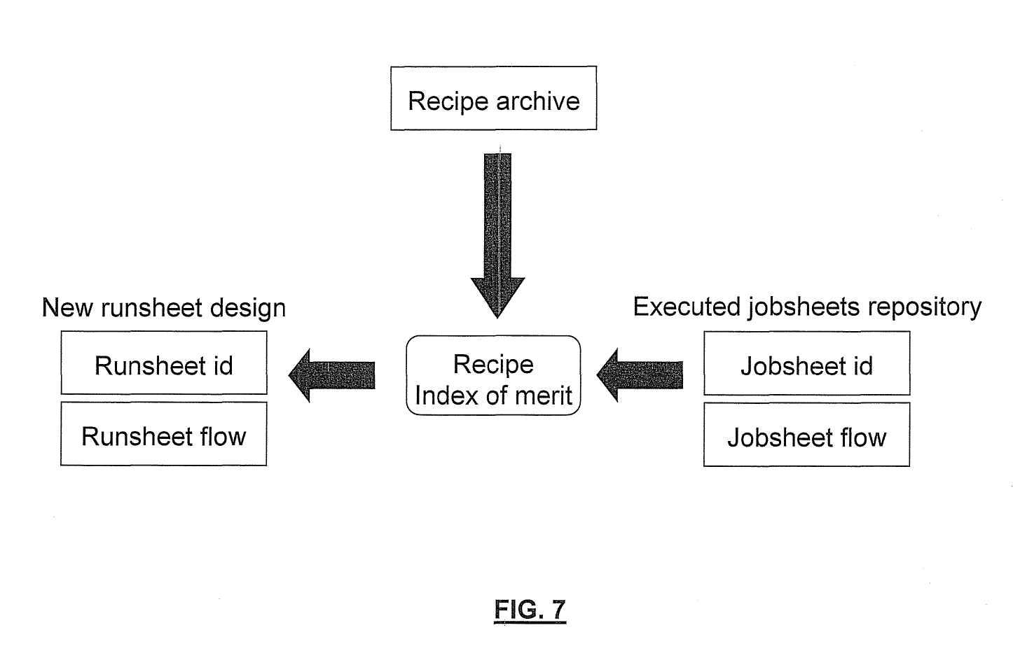

FIG. 7 outline the feedback path from wafer processing to design feeding recipe indices of merits. These indices are automatically updated to latest processing results so giving up-to-date addressing while designing new process flows. Furthermore, information about the context of use of a recipe is directly available together with the index. Questions like ‘who was the responsible of the jobsheet where the recipe was used?’ or ‘what processing was done before this failing recipe?’ can be answered by the user, thus helping in further sharing of highly specialized knowledge.

The operation to define a runsheet is particularly critical as it determines, directly and completely, the processing of substrates of material, in particular for developing and producing micro- and nano-technology devices.

Therefore, in accordance with the present invention, a method has been developed to address the design of a new runsheet, hereinafter called “recipe reliability function”, which allows the “history” of the stored recipe to be verified and used, actively supporting the selection of appropriate recipes, during the process to create a runsheet.

In particular, the method forming the subject matter of the present invention provides for a planning phase wherein the number, type of information and at least one index of merit to support the decision-making step are defined. Recipe identifiers are linked to jobsheet macros in order to allow direct link between processing results and recipes. For each jobsheet macro, a state attribute distinguishes among different possible execution results, among which: success, failure, reworking, aborted. For each jobsheet macro a result comment area is planned too where details about processing can be stored. The direct link of a recipe to a jobsheet macro allows completely describing the context of use of the recipe itself, and the availability of result comments allows to link knowledge to processing results. Further knowledge is available since it is possible to extract the context of use of a recipe, e.g., in what process type, after what process part.

In a subsequent phase, following each jobsheet, said information relative to each recipe of which the production process is composed is entered in a DBMS (database management system).

Jobsheet flow, Jobsheet id and Recipe archive structures in FIG. 5 list information classes to be managed in order to design and implement the planning phase of a system based on the method.

Finally, there is a phase to compile the macros, of which a runsheet is formed, during which said function, recipe reliability function, aids in the decision-making step.

Said phase is repeated the same number of times as the number of macro instructions forming a runsheet.

The steps forming the compilation phase are illustrated below with reference to the flow chart in FIG. 4:

In step 1 compilation starts, comprising repetition thereof for the same number of times as the number of macro instructions forming a runsheet, i.e. completion of the information of each recipe, or modification of the recipes copied from other runsheets, starts.

Then in step 2 a macro instruction to be acted on is selected, bearing in mind that it is not necessary to compile/modify the macros in the order in which they are performed in said runsheet.

Then in step 3 the name of a recipe to be used for the macro instruction being compiled is selected.

Then, if the recipe selected is already present in a file, in step 4 a recipe reliability function is called up, capable of calculating at least one index of merit indicating the validity of said recipe and concerning the degree of reliability and use of the recipe selected in step 3.

More specifically, using indices of merit obtained by interrogating the DBMS database, indications are obtained on how many times the recipe in question has already been entered in runsheets, how many times it has been used successfully in jobsheets (production batches) and, in the event of problems during use of the recipe, information regarding these problems, e.g.: cause of failure, jobsheet in which they occurred, person responsible for the jobsheet.

Therefore, it is evident that the DBMS must be continually updated, otherwise the selection of a recipe is not provided with said useful information and indices of merit. This is automatically managed by jobsheet information.

An example of implementation of the recipe reliability function can be expressed by SQL queries:
“select person in charge from ‘DBMS’ where name_recipe=‘example”
“select jobsheet from “DBMS” where name_recipe=‘example and result=‘true’”
“a=number_lines (select jobsheet from “DBMS” where name_recipe=‘example and result=‘true’); b=number_lines (select jobsheet from ‘DBMS’ where name_recipe=‘example); index_positivity=a/b″
“select jobsheet, name_recipe, notes from “DBMS” where result=‘false’”

Then check, step 4, if the recipe selected is already present in a file.

If present, then in step 5 a recipe reliability function is called up, capable of calculating at least one index of merit indicating the validity of said recipe and regarding the degree of reliability and use of the recipe selected in step 3. In particular, said recipe reliability function provides the information relative to the recipe selected from the file and at least one index of merit. FIG. 6 show a possible design of information classes to be managed in the DBMS referred in FIG. 4. FIG. 7 details information paths among information structures.

On the basis of the information obtained through said recipe reliability function in the previous step, in step 6 (FIG. 4) it is decided whether to consider the recipe selected suitable for the runsheet being compiled.

If the recipe selected is considered suitable, then in step 8 the recipe is stored in a DBMS, otherwise if the recipe is not correct, it is decided, in step 7, whether to return to step 3 in which a new recipe is selected, or to exit the compilation phase by going to step 10.

If the correct recipe is not present in said file in step 4, in step 40 this can be created from scratch or be implemented on the basis of a pre-existing recipe present in said file which is suitably modified and stored in said DBMS in step 8. After compiling and storing a recipe in step 8, in step 9 it is decided whether to compile a new recipe or to exit the compilation phase by going to step 10.

The compilation phase can be abandoned at any time, saving the settings entered up to that point so that it can be returned to subsequently, or it can be abandoned without saving: in fact, in another preferred embodiment of the method, if there is no pre-existing recipe, then from step 4 the compilation phase can be exited directly, step 10, and returned to later after a recipe suitable for the purpose has been prepared separately, e.g. when the recipe is completely new and requires the action of a specific technologist.

If deemed necessary at the end of a compilation, comments can be noted on the criterion for choosing the information to be recorded in the DBMS at the end of each processing operation, or on the criteria for calculation of said at least one index of merit, so that modifications to the operations performed during the planning phase are always possible.

Advantageously, during compilation of a runsheet it is always possible to store comments regarding the quality and suitability of some types of feedback information and indices of merit chosen in the planning phase, so that it is always possible to improve the efficacy of the recipe reliability function.

In other words, by selecting a pre-existing recipe, the operator immediately benefits from previously stored information, such as comments, results, details, but also indices of merit processed in real time, such as statistics.

If said recipe is new, no decision-making support can be offered and it is merely stored in the database.

If the runsheet was not completed it is resumed to from the recipe selection step, otherwise the block is exited.

Advantageously, said information can vary in relation to the type of processing and to the production sector of reference.

For the present method to be implementable in a wide variety of production sectors, in concordance with the “Planning” block, it is possible to customize the information and cost functions that are most useful for decision-making support before implementing said method.

In said preferred embodiment, at the end of compiling a runsheet, if the information received during the decision-making step on pre-existing recipes is not considered satisfactory, modifications can be made to the type and number of information to be stored at the end of each jobsheet.

A device that allows implementation of the method of the present invention comprises:
storage means in which to store both the feedback of each jobsheet and relative macros of which it is composed, and the history of each runsheet, so as to keep track of every modification made;
means to view information, i.e. a text and graphics interface;
means to compile a runsheet having all or some of the recipes that have been progressively stored in the database;
means to compile a new recipe having all or at least some of the processing operations that have been progressively stored in the database;
means to process feedback from recipe reliability function in order to obtain at least one index of merit of the recipes tested.

In a preferred embodiment, the information viewed relative to a recipe comprises:
a list of jobsheets that have used said recipe;
a list of the technical personnel responsible for the project who were involved in said jobsheets;
a list of the results of the macros that have been based on said recipe;
a list of comments and notes on the macros that have been based on said recipe;
at least one index of merit of said recipe, i.e. number of positive results divided by the total number of times that the recipe has been used, together with time information to evaluate how old or new the recipe is and better evaluate the index of merit
a list of comments for recipes whose processing was considered not successful

Therefore, the present invention can advantageously be implemented through a computer program, for example written in Java and SQL or ASP and SQL, comprising means to store, process, present and code data for the implementation of one or more steps of the method, when this program is run on a computer. Therefore, it is intended that the scope of protection extends to said computer program and also to means readable by computers comprising a recorded message, said means readable by computers comprising program coding means to implement one or more steps of the method, when this program is run on a computer.

The advantages deriving from application of the present invention are clear, as this method benefits from an increase in reliability over time due to the increase in information and experimental data stored in the system of reference.

The invention can be applied in industry by implementing it in information systems which will actively contribute to save developing time and to help in the design of process flows with high success rate, particularly in the field of development and production of micro- and nano-technology devices in cleaning room laboratories. In an environment in which technology is particularly dynamic, the definition of new recipes is a very important activity.

In this context, sharing know-how and easy and clear access to process results allows a decrease in the possibility of errors and in the times required to develop new runsheets.

The recipe reliability function proposes for the first time an automatic and general connection between design functions and recipe history and processing results, allowing process flows to be developed with increasing safety with high probability of success, thanks to an analysis of the results of processing operations on substrates integrated in the definition function of runsheets.

In fact, it allows design choices to be implemented thanks to knowledge from previous processing operations and processing context information.

It solves the problem of choosing appropriate recipes, decreasing the risk of incorrect processing operations and contributing to decreasing the times required to develop new processes.

This is thanks to the possibility of easily identifying reliable recipes and the personnel responsible for technologies, e.g. those in charge of the jobsheets analyzed.

The present invention can advantageously be implemented through a computer program which comprises coding means for the implementation of one or more steps of the method, when this program is run on a computer. Therefore, it is intended that the scope of protection extends to said computer program and also to means readable by computers comprising a recorded message, said means readable by computers comprising program coding means to implement one or more steps of the method, when said program is run on a computer.

Variants of the non-limiting example described are possible, without however departing from the scope of protection of the present invention, comprising all equivalent embodiments for those skilled in the art.

From the description above those skilled in the art are capable of implementing the subject matter of the invention without introducing further constructional details.

1-15. (canceled)

16. A process flow, in particular for a procedure for the production of micro- and nano-technology devices in cleanroom laboratories, comprising the following steps:
a planning step, wherein the number and type of information and at least one index of merit are defined, to build up one or more recipes to support the decision-making phase for the production process;
a storing step, following each production process, wherein said information relative to each recipe is stored in a data-base;
a make-up step for obtaining a runsheet, wherein the recipes are selected by means of a “recipe reliability function”, which supplies said information relative to said recipes and said at least one index of merit, for the selection of the most reliable and appropriate recipes for the production process flow under development.

17. A process flow according to claim 16, wherein said make-up step comprises the following steps:
compilation starts, comprising the repetition thereof for the same number of times as the number of macro instructions forming a runsheet;
then a macro instruction to be acted on is selected, bearing in mind that it is not necessary to compile/modify the macros in the order in which they are performed in said runsheet;
then the name of a recipe to be used for the macro instruction being compiled is selected;
then it is checked whether the recipe selected is already present in a file;
if the recipe selected is already present in a file, then said recipe reliability function is called up, capable of calculating at least one index of merit indicating the validity of said recipe and concerning the degree of reliability and use of the recipe selected;
on the basis of the information obtained through said recipe reliability function in the previous step, it is decided whether to consider the recipe selected suitable for the runsheet being compiled;
If the recipe selected is considered suitable, then the recipe is stored in a data-base management system,
otherwise if the recipe is not correct, it is decided whether to return to the step in which a new recipe is selected or to exit the compilation phase;
otherwise, if the recipe is not present, a recipe is created from scratch or it can be implemented on the basis of a pre-existing recipe present in said file, which is suitably modified and stored in said data-base management system;
after compiling and storing a recipe, it is decided whether to compile a new recipe or to exit the compilation phase.

18. A process flow according to claim 16, wherein said planning step comprises the following steps:
definition of the number and type of information useful for the decision-making process;
definition of the cost functions and indices or merit relative to said recipes;
so that it is possible to adapt the method to different technology sectors.

19. A process flow according to claim 17, wherein said compilation can be interrupted at any time, saving the settings entered up to that point so that it can be returned to subsequently.

20. A process flow according to claim 16, comprising a further step wherein any deficiencies in the type and number of information stored are noted at the end of each production so as to integrate and/or modify the information provided during the planning step.

21. A process flow according to claim 16, wherein said information comprises:
a list of jobsheets that have used said recipe;
a list of the technical personnel responsible for the project who were involved in said jobsheets;
a list of the results of the macros that have been based on said recipe;
a list of comments and notes on the macros that have been based on said recipe;
at least one index of merit of said recipe.

22. A process flow according to claim 16, wherein an index of merit is the number of positive results divided by the total number of times that the recipe has been included in a runsheet.

23. A method for the production management, in particular for a procedure for the production of micro- and nano-technology devices in cleanroom laboratories, using a process flow as in claim 16, comprising the following steps:
a process flow design step: said runsheet is compiled, describing the processing required to fabricate a device as outlined in a CAD/TCAD-like level, said runsheet comprising an ordered sequence of technological steps, with details of said one or more recipes;
a substrate processing step: a set of substrates is processed according to process flow specifications comprised in a jobsheet;
a dynamic technology driven process logs step: a set of tracing information is recorded during the wafer processing step, said tracing information being used for determining said “recipe reliability function” for said recipe selection, contributing to the runsheet compilation in said process flow design step.

24. A method for the production management as in claim 23, further comprising an additional step of traditional log processing, based on processing specific for class of recipes, like statistic process control and extraction of specific recipe parameters, for contributing to the runsheet compilation in said process flow design step.

25. A method for the production management as in claim 23, wherein in said dynamic technology driven process logs step said tracing information comprises a set of information which can be stored, extracted and processed independently from the technology and recipe structure, so as the same set of indices of merit and recipe history processing is available for all recipes selected while compiling new process flows.

26. Device for processing information to define process flows suitable to implement a method according to claim 16, comprising:
a storage memory storing both the feedback of each jobsheet and relative macros of which it is composed, and the history of each runsheet, so as to keep track of every modification made;
a display to view information, i.e. a text and graphics interface;
a first compile said runsheet having all or some of the recipes that have been progressively stored in said data-base management system;
a second compiler of a new recipe having all or at least some of the processing operations that have been progressively stored in the database management system;
a feedback processor in order to obtain at least one index of merit of the recipes tested.

27. Device according to claim 26, wherein the database management system comprises fields for the storage of
at least one jobsheet in relation with each macro of which it is composed;
names or serial numbers of technical personnel responsible for the project in relation with said jobsheets;
results of the macros that have been based on said recipe;
comments and notes on the macros that have been based on said recipe;
runsheets and any modifications made thereto up to the final jobsheet.

28. Device according to claim 26, wherein access thereto is based on WEB type navigation.
